(19) United States
(12) Patent Application Publication
(10) Pub. No.: US 2002/0099950 A1
(43) Pub. Date: Jul. 25, 2002

(54) Method of maintaining integrity of an instruction or data set

(76) Inventor: Kenneth K. Smith, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 09/767,606

(22) Filed: Jan. 22, 2001

(51) Int. Cl. G06F 12/14

(52) U.S. Cl. 713/200

(57) ABSTRACT

In combination with a computer system having a special modifiable memory, such as Flash ROM or a system partition of a hard disk drive, in which is loaded an original code set, a method for maintaining the integrity of the contents of that modifiable memory when the system attempts to overwrite the contents with a different code set. The developer of a code set (e.g., a BIOS) that is generally stored in a modifiable memory selects a one-way algorithm, which is maintained as a company secret. Whenever a new version of the code is made available, whether as a downloadable Internet file or on a removable medium, the loadable code is always accompanied by a security key which was generated by having the one-way function operate on the new code set. In order to prevent unauthorized modifications to code stored in a modifiable memory, a computer system is equipped with a custom memory controller having an embedded, hard-wired copy of the secret one-way function. The system applies the embedded one-way function to the new code version and calculates a local. The local key is compared with the security key. If two keys match, the memory controller permits the new code version to be loaded into the modifiable memory.

### FIELD OF THE INVENTION

This invention relates to data processing systems and, more specifically, to the protection of instruction or data sets contained in modifiable memory from malicious or unintentional modification.

### BACKGROUND OF THE INVENTION

The ROM BIOS, or read-only memory basic input/output system, provides crude information and instructions required to get the various components of a computer system to function in concert. In modern computer systems, the BIOS has three main functions. Firstly, it performs a test called the Power-On Self Test, or POST. The POST tests the computer's memory, motherboard, video adapter, disk controller, keyboard, and other essential components. Secondly, it finds the operating system and loads, or boots, it. If an operating system is found, it is loaded and given control of the computer. Thirdly, after the operating system is loaded, the BIOS works with the processor to facilitate access by software to certain resident devices, such as the video controller and hard disk drive.

The BIOS is responsible for the operability of DOS and Windows® on any IBM-compatible personal computer system, in spite of hardware differences between them. Because the BIOS communicates with hardware, it is, necessarily, hardware specific, and must match a particular hardware configuration exactly. Instead of developing their own BIOS (by no means, a trivial task), most motherboard manufacturers have chosen to license a BIOS from a company that specializes in BIOS development, such as American Megatrends, Inc. (AMI) Award Software, Microid Research, or Phoenix Technologies, Ltd. Even then, the tailoring of a standard existing BIOS code to a particular motherboard is a lengthy and complicated process.

Virtually every modern motherboard employs an integrated chipset, which consists of several chips which perform the functions that were previously performed by hundreds of chips on the original IBM-AT motherboard. Each chipset requires its own BIOS. If the BIOS does not initialize the registers of the resident chipset properly, the system will not boot, nor will any special features of the chipset be implemented.

Because new, higher performance hardware components are being constantly developed, it stands to reason that no BIOS code can be prophetically endowed so as to accommodate all future hardware developments. Some of the most significant BIOS updates in the past provided for: recognition of higher-capacity floppy disk drives; the elimination of controller- or device-driver-based hard disk parameter translation for MFM, RLL, IDE or ESDI drives with 1,024 or fewer cylinders, by providing a user-definable hard drive type matched to the drive; support for block-mode Programmed I/O (PIO) transfers for Fast-ATA and Enhanced-IDE hard disk drives; support for 101-key enhanced keyboards; support for Novell networks; support for SVGA displays; password protection; virus protection; the addition of Plug-and-Play features; and support for processors that did not exist when the BIOS code was written.

Recognizing the need for periodic BIOS updates to maintain system functionality at levels on par with available technology, motherboard manufacturers have generally made it possible to upgrade the BIOS independent of the motherboard. The BIOS code for many early personal computers was typically stored in an erasable programmable read-only memory (EPROM), which was plugged into a socket on the motherboard. Either the EPROM could be unplugged and replaced in its entirety with an EPROM containing updated code, or the original EPROM could be erased by subjecting it to ultraviolet light and, then, reprogrammed with updated code using an EPROM programmer device. The BIOS for most modern motherboards is stored in Flash ROM, a type of electrically-erasable, programmable read-only memory, that can be erased and reprogrammed directly in the system without using ultraviolet light and an EPROM programmer device. The use of Flash ROM permits a manufacturer to send out ROM upgrades on disk, which can be loaded into the Flash ROM chip on the motherboard without removing and replacing the chip. To ensure that the updated BIOS code is properly written to the flash ROM, the writing operation is typically monitored by Cyclic Redundancy Checking (CRC). CRC is an error-detection technique consisting of a cyclic algorithm performed on each block or frame of data. That is to say that a CRC code corresponding to the data block written into the ROM is compared with a CRC code corresponding to the same data block reread from the ROM. If the codes are not identical, an error must have occurred, and the write operation is repeated until the CRC codes match. An alternative BIOS scheme similar to a Flash ROM has been used by IBM. This technique relies on an Initial Microcode Load (IML) which only instructs the system to access a special, hidden system partition on the hard disk drive which contains the rest of the BIOS code. The BIOS code resident within the system partition, which may be easily rewritten using a special system command, is loaded every time the system is powered up.

The Flash ROM in many systems is write-protected. Protection must be disabled before performing an update, usually by opening the system case and changing the position of a jumper or a switch. Without the lock, any program that knows the right instructions can rewrite the system ROM. Without write protection, it is conceivable that a virus program could be written that would copy itself directly into the ROM BIOS of the system. Of course, the IML scheme is at least as vulnerable to malicious modification or an unintentional modification as is the Flash BIOS.

What is needed is a method to prevent malicious or unintentional modifications of the code stored in modifiable memories.

### SUMMARY OF THE INVENTION

This invention makes use of a one-way function to prevent malicious or unintentional modifications to code stored in an otherwise unprotected special modifiable memory, such as a Flash ROM or system partition of a hard disk drive. By utilizing a hardware-defined one-way function or algorithm, a computer system can determine whether or not a particular code image that the system has been commanded to write to the special modifiable memory is a correct, or authorized, image. The one-way function is chosen, for example, by a software development company, such as a BIOS provider, and is maintained a company secret. As the one-way function is never revealed through operation of the computer system, it cannot be easily duplicated or recreated. When a new code set is developed, the developer subjects the new code set to the one-way function and calculates a security key. Whenever a new version of the code is made available, whether as a downloadable Internet file or on a removable medium, the loadable code is always accompanied by the security key.

According to one embodiment of the invention, in order to prevent unauthorized modifications to code stored in a modifiable memory, a computer system is equipped with a memory controller having an embedded, hard-wired copy of the secret one-way function. The memory controller is coupled to both the modifiable memory and the system microprocessor. Before the memory controller will allow a code set, or image, to be loaded into the modifiable memory, it must determine that the accompanying security key matches a local key that the system generates by having the embedded one-way function act on the new code set. The code image is loaded into system main memory and the memory controller, knowing the starting location length of the code image data, instructs the CPU to operate on the code data using the embedded one-way function. If the generated key matches the security key provided with the updated code, the code is assumed to be legitimate. The memory controller will then write the tested and validated code set into the modifiable memory, whether it be a Flash ROM, a system partition on the hard disk drive, or some new type of modifiable memory yet to be developed. However, if the key generated by the memory controller does not match the security key provided with the updated code, an error message contained in the memory controller is sent to the system operator, and the modifiable memory write operation is terminated.

In another embedment, in order to make the method more tamper-resistant, the memory controller is equipped with an on-chip special-purpose processor and an on-chip non-modifiable memory for storing the one-way function. By limiting accessibility of the non-modifiable memory to the special-purpose processor, rather than the computer system's general-purpose CPU, confidentiality of the one-way function is more likely to be maintained. Thus, processing of the new code image using the one-way function to generate a local key and comparison of the local key with the security key provided with the updated code set are handled exclusively by the memory controller, thereby eliminating potential security leaks which might occur through low-level monitoring of system memory registers.

### DESCRIPTION OF THE DRAWINGS

FIG. 1 is a block diagram of a computer system which utilizes the invention.

FIG. 2 is a block diagram of a first embodiment of a memory controller in accordance with the invention.

FIG. 3 is a block diagram of a second embodiment of a memory controller in accordance with the invention.

### DETAILED DESCRIPTION OF THE INVENTION

This invention makes use of a one-way function to prevent malicious or unintentional modifications to code stored in an otherwise unprotected special modifiable memory, such as a Flash ROM or system partition of a hard disk drive. By utilizing a hardware-defined one-way function or algorithm, a computer system can determine whether or not a particular code image that the system has been commanded to write to the special modifiable memory is a correct, or authorized, image. The one-way function is chosen by a software development company, such as a BIOS provider, and is maintained a company secret. As the one-way function is never revealed through operation of the computer system, it cannot be easily duplicated or recreated.

The one-way function may be as simple or as complex as desired. However, the primary goal of the use of the one-way function is to ensure that a special modifiable memory, such as the BIOS, is not modified in a manner inconsistent with the desires of the system user. Thus, the method of the present invention is designed to prevent write operations by viruses, relatively-determined hackers, and the loading of defective code sets. Although a standard Cyclic Redundancy Check (CRC) on the code set might prevent the loading of a defective code set into the modifiable memory, it may not prevent vandalism by a hacker or modification of the special modifiable memory by a virus. On the other hand, the use of a one-way function such as the RSA Algorithm may be overkill, as the overhead required to implement the invention using that algorithm would be considerable. Nevertheless, as the use of such complex algorithms do fall within the scope of this invention, a brief description of the algorithm and its method of implementation for the purposes of this invention is in order. The RSA Algorithm is an encryption algorithm developed by Ronald Rivest, Adi Shamir and Leonard Adelman. This particular algorithm is disclosed in U.S. Pat. No. 4,405,829. This patent is incorporated herein, by reference, in its entirety. The algorithm is used extensively to provide security for communications over an insecure channel and for “digital signatures.” On the Internet, it has been used by the encryption program, Pretty Good Privacy (PGP), Netscape Navigator, Microsoft Internet Explorer, and by Mastercard and VISA in the Secure Electronic Transactions (SET) protocol for credit card transactions.

A one-way function is a mathematical operation that is simple to calculate in one direction, but extremely difficult to do in reverse. In other words, once a data set has been transformed by the one-way function to create a resultant data value, neither the data set nor the one-way function can be easily ascertained from the resultant data value.

The RSA system uses a system of modular arithmetic to transform a message into encrypted data (ciphertext). Modular arithmetic is often called “clock” arithmetic, because addition, subtraction, multiplication and division work like reading time on 12-hour clock. That is to say that 12, or multiples of 12 are subtracted from the result. The process is sometimes called modular reduction. By subtracting out the modulus (and all multiples thereof), a number is “reduced” to a much smaller number.

In the RSA encryption formula, a message (represented by a number M) is raised to a power (e), and the product is then divided by a modulus (n), leaving the remainder as a ciphertext (C). The formula is, thus, stated as follows:

C=M^{e} mod n

The modulus (n) is a composite number, constructed by multiplying two prime numbers, (p) and (q) together. When the number n is large (200 digits or so), even the fastest computers using the fastest known methods cannot recover the message (M), even when (C) and the key used to create it [(e) and (n)] are known.

For the decryption operation, the following formula is used:

M=C^{d} mod n

The encryption and decryption exponents, (d) and (e) respectively, are related to each other and to the modulus (n) in the following manner:

d=e⁻¹ mod ((p-1) (q-1))

In order to calculate the decryption key, one must know the factors (p) and (q), which are used to calculate the modulus (n).

Thus, use of the RSA Algorithm generally requires three steps: The first step is key generation, in which (p) and (q) are chosen and multiplied together to get the modulus (n), an encryption exponent (e) is chosen, and the decryption exponent (d) is calculated using (e), (p) and (q). The second step is encryption, in which the message (M) is raised to the power (e), and then reduced modulo (n). The third step is decryption, in which the ciphertext (C) is raised to the power (d), and then reduced modulo (n).

The RSA Algorithm may be used to implement the present invention in the following manner. The developer of the updated code set can pass the updated code set through the algorithm and generate an encrypted code set. Both unencrypted and encrypted versions of the updated code set are made available for the update procedure. Before the code can be written into the modifiable memory, the memory controller must pass the delivered code set through its embedded one-way function and compare the encrypted result with the delivered encryption. If the two match, the code is deemed to be an authorized code set from the code provider. If the encrypted result does not match the delivered encryption, an error message is sent to the system and the write operation will fail.

Use of a one-way function somewhere between the simplicity of a standard cyclic redundancy check and the complexity of the RSA Algorithm is the currently preferred implementation of the invention. For example, the security key (K) could be calculated by taking the modulus of the code set's CRC value (V) raised to a particular power (x). In mathematical terms, K=V^{x} mod n. The advantage of an algorithm such as this is that V is a relatively manageable number compared to the entire code, or data, set, and would require far less processing overhead than would encryption of the entire code set. Any number of other reasonably secure algorithms are possible. The focus of this invention, however, is not a particular algorithm, but rather the use of an algorithm to generate a security key from an updated code set, the security key being provided with distributions of the updated code set, the embedding of the algorithm in memory controller used on a computer system having modifiable special memory designed to receive such an updated code set, effecting a comparison of the security key with a local key generated by subjecting the updated code set to the embedded algorithm, and authorizing the loading of the updated code set into the modifiable memory if the local key matches the security key.

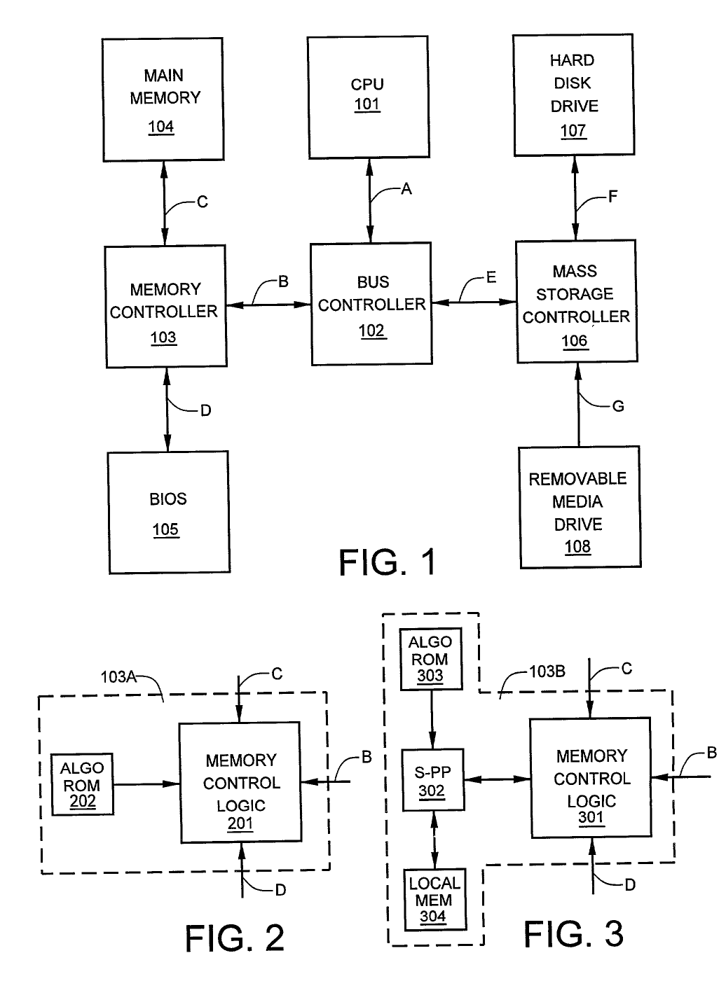

Referring now to the computer system of FIG. 1, a central processor unit (CPU), or microprocessor 101 communicates with a bus controller 102 over a processor bus A. The bus controller 102 communicates with a memory controller 103 over memory bus B. The memory controller communicates with a main memory 104 over a first local memory bus C and with a BIOS stored in a modifiable memory 105 over a second local memory bus D. The bus controller 102 also communicates with a mass storage controller 106 over main system bus E. The mass storage controller 106 communicates with a hard disk drive 107 via a first local storage bus F, and with a removable media drive 108 via a second local storage bus G.

Referring now to FIG. 2, for a first embodiment of the invention, a memory controller includes memory control logic 201 coupled to a read only memory (ROM) 202 in which is stored the one-way algorithm. In order to implement the new method, a security key generated by the developer of a new code image is packaged with the new code image. Both the new code image and the security key are loaded on the removable media drive 108 or downloaded to the hard disk drive 107 from a remote site. The new code image and security key are then loaded into the main memory 104, the processor 101 loads the one-way algorithm from the ROM 202 and computes a local key form the new code image. The processor then compares the local key with the security key. If the two values are identical, the memory control logic 201 permits the processor to write the new code image into the modifiable memory 105.

Referring now to FIG. 3, for a second embodiment of the invention, a memory controller 103B includes memory control logic 301 which communicates with a special-purpose processor 302. The special purpose processor 302 accesses both a ROM 303 in which is stored the one-way algorithm and a local memory 304 in which the new code image and intermediate calculations performed by the special-purpose processor 302 can be stored and intermediate calculations can be stored as the special purpose processor 302 calculates a local key using the new code image stored in the local memory 304 and the one-way algorithm downloaded from the ROM 303. By performing all calculations related to the generation of a local key and comparing the local key with the security key within the memory controller 103B, itself, and by preventing the one-way algorithm from being loaded into main memory 104, the one-way algorithm is far less likely to be ascertained by a determined hacker.

It should be clear that a similar protection scheme may be employed to protect a partition on the hard disk drive in which the BIOS is stored for an IML system implementation. In such a case, the mass storage controller 106 may be equipped as were the memory controllers 103A and 103B.

Although only several embodiments of the method for maintaining the integrity of an instruction or data set are disclosed herein, it will be obvious to those having ordinary skill in the arts of cryptography and data processing systems that changes and modifications may be made thereto without departing from the invention as hereinafter claimed.

What is claimed is:

1. In combination with a computer system having a special modifiable memory in which is loaded an original code set, a method for maintaining the integrity of the contents of that modifiable memory when the system attempts to overwrite the contents with a different code set, said method comprising the steps of:
providing a one-way algorithm which acts on a replacement code set and generates a security key unique to the replacement code set, said algorithm being maintained confidential by the provider of the replacement code set;
providing the security key in combination with distributions of the replacement code set;
providing a memory controller having an embedded copy of the algorithm, said memory controller causing a tendered code set, which the computer system attempts to write into the modifiable memory, to be acted on by the embedded copy, thereby generating a local key;
comparing the local key with the security key;
allowing the contents of the modifiable memory to be overwritten only if the local key matches the security key.

2. The method of claim 1, wherein said original code set contains data and/or instructions crucial to the proper functioning of the computer system.

3. The method of claim 1, wherein the computer system also includes a microprocessor and a main memory.

4. The method of claim 3, wherein said different code set is loaded into main memory and said microprocessor executes said algorithm on said tendered code set, compares the security key to the local key, and provides the results of the comparison to the memory controller.

5. The method of claim 1, wherein said memory controller further includes an on-chip special-purpose processor and an on-chip non-modifiable memory for storing said algorithm, and access to said non-modifiable memory is limited to the special-purpose processor.

6. The method of claim 5, wherein said special-purpose processor loads said algorithm from the non-modifiable memory, calculates a local key for the tendered code set, and compares the local key with the security key.

7. The method of claim 1, wherein said algorithm employs modular arithmetic.

8. The method of claim 1, wherein said algorithm employs a cyclic redundancy check.

9. A method for preventing malicious and defective overwrites of a basic input/output system (BIOS) code of a computer system where said BIOS code is stored in modifiable memory, said method comprising the steps of:
providing a one-way algorithm which acts on a replacement BIOS code and generates a security key unique to the replacement BIOS code, said algorithm being maintained confidential by the provider of the replacement code set;
providing the security key in combination with distributions of the replacement BIOS code;
providing a memory controller for said computer system, said memory controller having an embedded copy of the algorithm, said memory controller causing any tendered code, which the computer system attempts to write into the modifiable memory, to be acted on by the embedded copy, thereby generating a local key;
comparing the local key with the security key;
allowing the contents of the modifiable memory to be overwritten with the tendered code only if the local key matches the security key.

10. The method of claim 9, wherein the computer system also includes a microprocessor and a main memory.

11. The method of claim 10, wherein said tendered code is loaded into main memory and said microprocessor executes said algorithm thereon, calculates a local key, compares the security key to the local key, and provides the results of the comparison to the memory controller.

12. The method of claim 9, wherein said memory controller further includes an on-chip special-purpose processor and an on-chip non-modifiable memory for storing said algorithm, and access to said non-modifiable memory is limited to said special-purpose processor.

13. The method of claim 12, wherein said special-purpose processor loads said algorithm from said non-modifiable memory, calculates a local key for the tendered code, and compares the local key with the security key.

14. The method of claim 9, wherein said algorithm employs modular arithmetic.

15. The method of claim 9, wherein said algorithm employs a cyclic redundancy check.

16. A method for ensuring that only an accurate copy of an authorized correct code set containing data and/or instructions crucial to the proper functioning of a computer system can be written to a modifiable memory of that computer, said method comprising the steps of:
providing a one-way algorithm that arithmetically manipulates an authorized code set to generate a security key unique to that code set, said algorithm being maintained confidential by the provider of the authorized code set;
providing the security key in combination with distributions of the authorized code set;
providing a memory controller for said computer system, said memory controller having an embedded copy of the algorithm, said memory controller causing any tendered code, which the computer system attempts to write into the modifiable memory, to be arithmetically manipulated by the embedded copy, thereby generating a local key;
comparing the local key with the security key;
allowing the contents of the modifiable memory to be overwritten with the tendered code only if the local key matches the security key.

17. The method of claim 16, wherein the computer system also includes a microprocessor and a main memory, and wherein said tendered code is loaded into said main memory and said microprocessor executes said algorithm thereon, calculates a local key, compares the security key to the local key, and provides the results of the comparison to the memory controller.

18. The method of claim 16, wherein said memory controller further includes an on-chip special-purpose processor and an on-chip non-modifiable memory for storing said algorithm, and access to said non-modifiable memory is limited to said special-purpose processor, and wherein said special-purpose processor loads said algorithm from said non-modifiable memory, calculates a local key for the different code, and compares the local key with the security key.

19. The method of claim 16, wherein said algorithm employs modular arithmetic.

20. The method of claim 16, wherein said algorithm employs a cyclic redundancy check.
